(19) United States
(12) Patent Application Publication
(10) Pub. No.: US 2015/0109086 A1
(43) Pub. Date: Apr. 23, 2015

(54) CORE AND COIL COMPONENT INCLUDING THE SAME

(71) Applicants: INDUSTRY-ACADEMIC COOPERATION FOUNDATION GYEONGSANG NATIONAL UNIVERSITY, Jinju (KR); SAMSUNG ELECTRO-MECHANICS CO., LTD., Suwon (KR)

(72) Inventors: Jae Sun WON, Suwon (KR); Tae Won HEO, Suwon (KR); Young Min LEE, Suwon (KR); Hwi Beom SHIN, Jinju (KR); Yong Hwan SHIN, Gwangyang (KR)

(73) Assignees: INDUSTRY-ACADEMIC COOPERATION FOUNDATION GYEONGSANG NATIONAL UNIVERSITY, Jinju (KR); SAMSUNG ELECTRO-MECHANICS CO., LTD., Suwon (KR)

(21) Appl. No.: 14/139,273

(22) Filed: Dec. 23, 2013

(30) Foreign Application Priority Data
Oct. 21, 2013 (KR) 10-2013-0125269

(51) Int. Cl. H01F 27/26

(52) U.S. Cl. CPC H01F 27/263
USPC 336/178; 336/212

(57) ABSTRACT

There are provided a core and a coil component including the same. The core includes core pieces coupled to each other, each of the core pieces including: a plurality of legs; a connection part connecting one ends of the legs to each other; and at least one contact part formed at a distal end of at least one of the legs in a manner in which a cross-sectional area of the leg may be decreased.

### CROSS-REFERENCE TO RELATED APPLICATION

This application claims the benefit of Korean Patent Application No. 10-2013-0125269 filed on Oct. 21, 2013, with the Korean Intellectual Property Office, the disclosure of which is incorporated herein by reference.

### BACKGROUND

The present disclosure relates to a core and a coil component including the same, and more particularly, to a core able to alleviate non-uniformity in magnetic flux and capable of being easily manufactured, and a coil component including the same.

Various kinds of power supply are required in various electronic devices such as televisions (TVs), monitors, personal computers (PCs), office automation (OA) devices, and the like. Therefore, such electronic devices generally include power supplies converting commercially available alternating current (AC) power into levels power required for respective electronic appliances.

Among the power supplies, a power supply having a switching mode (for example, a switched-mode power supply (SMPS)) has commonly been used. This SMPS includes various coil components such as a switching transformer.

Generally, switching transformers include a core and a bobbin, sizes of which are significantly decreased as compared with those included in general transformers, and may stably support low voltage and low current direct current (DC) power supplied to electronic appliances. Therefore, such switching transformers have been widely used in the electronic appliances tending to be miniaturized.

Meanwhile, cores included in coil components such as transformers may be generally divided into center gap type cores in which a gap is formed in a center leg of an EE type core, side gap type cores in which gaps are formed in both side legs of the EE type core, respectively, and center-side gap type core in which the center gap type core and the side gap type core are combined with each other.

Here, in the case of center gap type cores, since a coil is wound within the gap, an eddy current interlinked with the coil may be generated, such that winding loss is caused.

The side gap type core or the center-side gap type core may have advantages, in that winding loss may be decreased with the use thereof, as compared with the center gap type core. However, in the side gap type core or the center-side gap type core, since the gaps should be formed on both of the side legs, when a pair of cores are manufactured and coupled to each other, it may be difficult to accurately control a distance between the gaps of the side legs.

According to the related art, in the side gap type core or the center-side gap type core, a method of maintaining the distance between the gaps by inserting cores having different magnetic permeability into the gaps or using an insulator has been used. However, in the method according to the related art, since different materials should be inserted into the gaps, the number of processes required for manufacturing the coil component is increased, such that manufacturing costs and a rate of defects are increased.

In addition, in the case in which thicknesses of the materials inserted into the gaps of both side legs are different, the distances between the gaps may be different, such that non-uniformity is generated in magnetic flux.

### RELATED ART DOCUMENT

(Patent Document 1) Korean Patent Laid-Open Publication No. 2012-0087529

### SUMMARY

An aspect of the present disclosure may provide a core capable of attaining an effect of a center-side gap, and a coil component including the same.

Another aspect of the present disclosure may provide a core capable of decreasing winding loss, and a coil component including the same.

Another aspect of the present disclosure may provide a core capable of being easily manufactured, and a coil component including the same.

According to an aspect of the present disclosure, a core may include core pieces coupled to each other, each of the core pieces including: a plurality of legs; a connection part connecting one ends of the legs to each other; and at least one contact part formed at a distal end of at least one of the legs in a manner in which a cross-sectional area of the leg may be decreased.

The core pieces may be coupled to each other while contacting each other through distal ends of the contact parts.

The contact part may protrude from the distal end of the leg in a stepped manner.

Each of the core pieces may further include at least one inclined surface connecting the distal end of the contact part and the distal end of the leg.

The core pieces may be coupled to each other while the distal ends of the contact parts contact each other.

The core pieces may be coupled to each other while the distal end of the contact part formed on any one of the core pieces contacts the distal end of the leg of the other of the core pieces.

The legs may include side legs disposed at both ends of the connection part and a center leg disposed between the side legs.

The contact parts may be formed at distal ends of the side legs, respectively.

The contact parts may be formed to be diagonal with respect to the center leg.

The contact parts may have a form in which they extend outer surfaces or inner surfaces of the side legs.

Air gaps may be formed in positions in which the legs face each other at outer sides of the contact parts.

According to another aspect of the present disclosure, a core may include: a plurality of legs; and a connection part connecting one ends of the legs to each other, wherein at least one of the legs includes at least one contact part having a form in which a cross-sectional area of the leg is decreased.

According to another aspect of the present disclosure, a coil component may include: a core formed by coupling at least two core pieces to each other; and a bobbin having a coil wound therein and having the core coupled thereto, wherein at least one of the core pieces includes legs, the legs including contact parts formed at distal ends thereof in a manner in which cross-sectional areas thereof are decreased and surface-contacting the other core piece.

The core pieces may be coupled to each other while contacting each other through distal ends of the contact parts.

Air gaps may be formed in positions in which the legs face each other at outer sides of the contact parts.

The contact part may function as an air gap in the case in which magnetic flux is increased and saturated in the core.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a perspective view schematically illustrating a coil component according to an exemplary embodiment of the present disclosure;

FIG. 2 is an exploded perspective view of the coil component shown in FIG. 1;

FIG. 3 is a side view of a core shown in FIG. 1; and

FIGS. 4 through 13 are perspective views illustrating cores according to other exemplary embodiments of the present disclosure.

### DETAILED DESCRIPTION

Hereinafter, embodiments of the present invention will be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions of elements may be exaggerated for clarity, and the same reference numerals will be used throughout to designate the same or like elements.

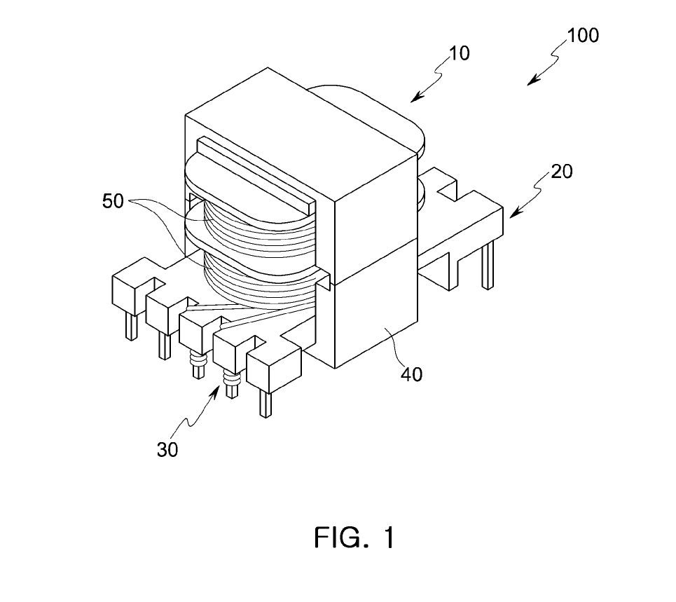

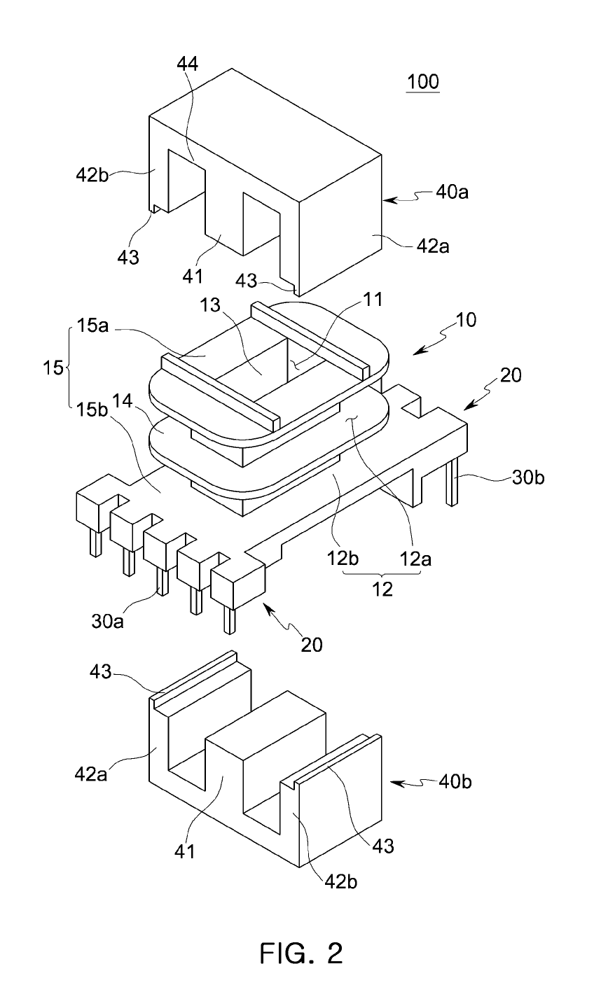

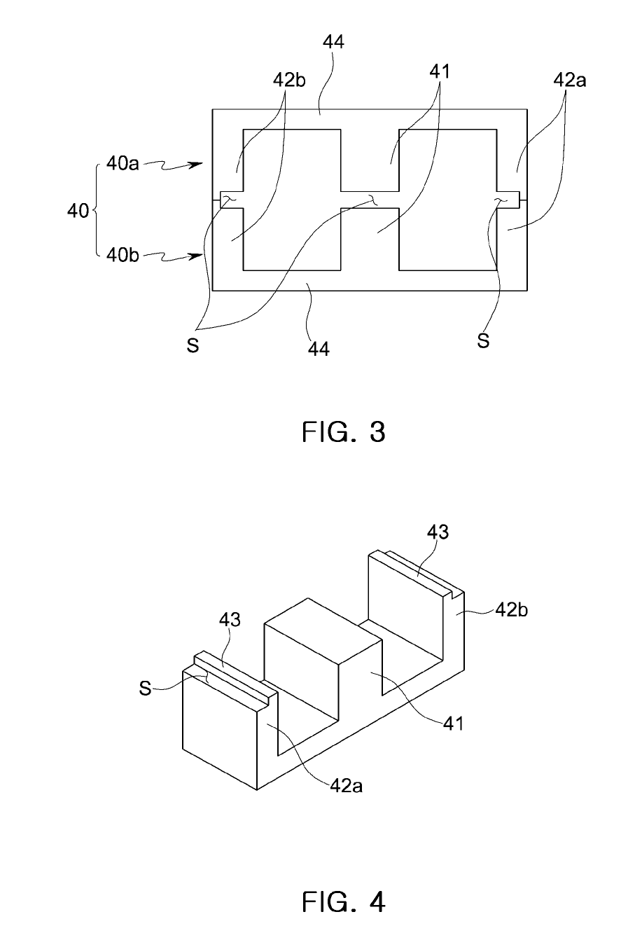

FIG. 1 is a perspective view schematically illustrating a coil component according to an exemplary embodiment of the present disclosure; and FIG. 2 is an exploded perspective view of the coil component shown in FIG. 1 in the state in which a coil is omitted. In addition, FIG. 3 is a side view of the core shown in FIG. 1.

Referring to FIGS. 1 through 3, the coil component 100 according to an exemplary embodiment of the present disclosure may be an insulated-type switching transformer and may include a bobbin 10, a core 40, and a coil 50.

The bobbin 10 may form an entire body of the coil component 100. The bobbin 10 may be easily manufactured by injection molding, but is not limited thereto. In addition, the bobbin 10 according to this exemplary embodiment may be formed of an insulating resin and may be formed of a material having high heat resistance and high voltage resistance. An example of a material of which the bobbin is formed may include polyphenylenesulfide (PPS), a liquid crystal polyester (LCP), polybutyleneterephthalate (PBT), polyethyleneterephthalate (PET), phenolic resin, and the like.

The bobbin 10 may include a winding part 12 having the coil 50 wound therein and a terminal connecting part 20 formed at one end of the winding part 12.

The winding part 12 may include a body part 13 having a pipe shape and a flange part 15 extended from both ends of the body part 13 in an outer diameter direction.

The body part 13 may include a through-hole 11 formed therein and at least one partition wall 14 formed on an outer peripheral surface thereof, wherein the through-hole 11 includes the core 40 partially inserted thereinto and the partition wall 14 partitions a space in a length direction of the body part 13. In this configuration, the coil 50 may be wound in respective spaces partitioned by the partition wall 14.

The winding part 12 according to this exemplary embodiment may include one partition wall 14. Therefore, the winding part 12 according to this exemplary embodiment may have two partitioned spaces 12a and 12b. However, the present disclosure is not limited thereto. That is, a plurality of spaces may be formed and used through a plurality of partition walls 14 if necessary.

The partition wall 14 may have various thicknesses and be formed of various materials as long as a form thereof may be maintained. In addition, although the case in which the partition wall 14 is formed integrally with the bobbin 10 has been described byway of example in this exemplary embodiment, the present disclosure is not limited thereto, but may be variously applied. For example, the partition wall 14 may also be formed as a separate member and be coupled to the bobbin 10.

The partition wall 14 according to this exemplary embodiment as described above may have approximately the same form as that of an upper flange part 15a to be described below.

The flange part 15 may protrude in a form in which it is extended from both ends, that is, upper and lower ends, of the body part 13 in the outer diameter direction. The flange part 15 according to this exemplary embodiment may be divided into an upper flange part 15a and a lower flange part 15b depending on positions thereof.

In addition, spaces between the outer peripheral surface of the body part 13 and the upper and lower flange parts 15a and 15b may be formed as the spaces 12a and 12b in which the coils 50 are wound. Therefore, the flange part 15 may serve to protect the coil 50 from the outside and secure insulation properties between the coil 50 and the outside, simultaneously with serving to support the coils 50 wound in the winding spaces 12a and 12b on both sides thereof.

The terminal connecting part 20 may be formed at the lower flange part 15b. More specifically, the terminal connecting part 20 according to this exemplary embodiment may have a form in which it protrudes from the lower flange part 15b in the outer diameter direction in order to secure an insulation distance.

However, the present disclosure is not limited thereto. That is, the terminal connecting part 20 may also have a form in which it protrudes from the lower flange part 15b in a downward direction.

Meanwhile, referring to FIG. 2, since the terminal connecting part 20 according to this exemplary embodiment has a form in which it is partially extended from the lower flange part 15b, it may be difficult to clearly distinguish between the lower flange part 15b and the terminal connecting part 20. Therefore, in the terminal connecting part 20 according to this exemplary embodiment, the lower flange part 15b itself may also be considered to be the terminal connecting part 20.

External connecting terminals 30 may be connected to the terminal connecting part 20 in a form in which they protrude outwardly.

In addition, the terminal connecting part 20 according to this exemplary embodiment may be divided into a primary terminal connecting part and a secondary terminal connecting part.

The terminal connecting part 20 may include a plurality of external connecting terminals 30 connected thereto. The external connecting terminals 30 may protrude outwardly from the terminal connecting part 20 and have various forms depending on a form or a structure of the coil component 100 or a structure of a substrate on which the coil component 100 is mounted.

The external connecting terminals 30 maybe divided into primary external connecting terminals 30a and secondary external connecting terminals 30b depending on an order of the coil 50 connected thereto.

The coil 50 may be wound in the winding part 12 of the bobbin 10 and include primary and secondary coils.

Each of the primary and secondary coils may include a plurality of individual coils that are electrically insulated from each other. However, the present disclosure is not limited thereto. That is, the number of individual coils of each of the primary and secondary coils may be appropriately changed if necessary.

In addition, the primary coil may be connected to the primary external connecting terminal 30a, and the secondary coil may be connected to the secondary external connecting terminal 30b.

The primary and secondary coils according to this exemplary embodiment may be wound in the spaces partitioned by the partition wall 14, respectively. Therefore, the insulation between the primary and secondary coils may be maintained by the partition wall 14.

Meanwhile, as the coil 50 according to this exemplary embodiment, a general insulated coil (for example, a polyurethane encased wire), or the like, or a twisted pair wire type coil formed by twisting several strands of wire (for example, a Litz wire, or the like) maybe used. Alternatively, a multi-insulated coil (for example, a triple insulated wire (TIW)) having good insulating properties maybe used. That is, a kind of the coil may be selected if necessary.

The core 40 may be partially inserted into the through-hole 11 formed in the bobbin 10 and be electromagnetically coupled to the coil 50 to form a magnetic path.

The core 40 may include two core pieces 40a and 40b coupled to each other in pairs. Here, the respective core pieces 40a and 40b may be partially inserted into the through-hole 11 of the bobbin 10 to contact each other and be coupled to each other. The core 40 may include, for example, an ‘EE’ core, an ‘EI’ core, a ‘UU’ core, a ‘UI’ core, and the like, depending on a shape thereof. In this exemplary embodiment, the case in which the ‘EE’ core is used has been described by way of example.

The core 40, which is a ferrite core including a plurality of legs 41, 42a, and 42b, may be used as a path for a magnetic fields generated by a current flowing in the coil 50.

The core pieces 40a and 40b may have the same shape and be coupled to each other. In this case, the core 40 maybe simply manufactured and be easily assembled.

In addition, the core pieces 40a and 40b may include a center leg 41 inserted into the bobbin 10 and side legs 42a and 42b disposed outwardly of the bobbin 10, respectively. Further, the center leg 41 and the side legs 42a and 42b may be connected to each other by a connection part 44 to thereby be formed integrally with each other.

The center leg 41 may be inserted into the through-hole 11 of the body part 13. Therefore, the center leg 41 may have a cross section having a shape corresponding to that of a cross section of the through-hole 11 and have a cross-sectional area smaller than that of the through-hole 11 so as to be easily inserted into the through-hole 11.

In this exemplary embodiment, the through-hole 11 may have a rectangular cross section. Therefore, the center leg 11 may also have a cross section having a shape similar to a rectangular shape.

A distal end of the center leg 41 may face a distal end of a center leg 41 of the other core piece 40a or 40b at approximately a central portion of the through-hole 11. As shown in FIG. 3, a gap S may be formed between the distal ends of the center legs facing each other. Here, the gap may mean an air gap.

The side legs 42a and 42b may be disposed in parallel with the body part 13 at an outer portion of the bobbin 10. Therefore, the side legs 42a and 42b may have a form in which both sides of the body part 13 of the bobbin 10 are enclosed.

Further, the side legs 42a and 42b according to this exemplary embodiment may have a cross section smaller than that of the center leg 41. More specifically, the side legs 42a and 42b may have a cross-sectional area corresponding to an area equal to half of a cross-sectional area of the center leg 41, but are not limited thereto.

The connection part 44 may connect the center leg 41 and the side legs 42a and 42b. Further, the connection part 44 may have a cross-sectional area smaller than that of the center leg 41, similar to the side legs 42a and 42b.

In addition, in the core according to this exemplary embodiment, when the core pieces 40a and 40b are coupled to each other, ends of the side legs 42 and 42b do not entirely contact each other, but may partially contact each other.

To this end, the core pieces 40a and 40b according to this exemplary embodiment may include protrusion-shaped contact parts 43 protruding from distal ends of the side legs 42a and 42b, respectively.

The contact parts 43 may protrude in a form in which they extend lengths of the side legs 42a and 42b from the distal ends of the side legs 42a and 42b.

The contact parts 43 maybe provided in order to decrease a cross-sectional area of a contact surface between the core pieces 40a and 40b as shown in FIG. 3 when the core pieces 40a and 40b are coupled to each other. Therefore, the contact parts 43 may have various shapes as long as they may decrease the cross-sectional areas of the side legs 42a and 42b.

In the core pieces 40a and 40b according to this exemplary embodiment, one contact part 43 may be formed on one side leg 42a or 42b. That is, the contact parts 43 maybe formed on both of two side legs 42a and 42b. In addition, the contact parts 43 may protrude such that they extend outer surfaces of the side legs 42a and 42b in a stepped manner.

Therefore, the core 40 according to this exemplary embodiment may be completed by coupling the contact parts 43 of the core pieces 40a and 40b to each other in a form in which the contact parts 43 contact each other.

Therefore, gaps S (or air gaps) may be formed between the distal ends of the side legs 42a and 42b by protrusion lengths of the contact parts 43. In this exemplary embodiment, the air gaps S of the side legs 42a and 42b may be formed at inner sides of the contact parts 43.

In addition, as described above, in the core 40 according to this exemplary embodiment, the contact parts 43 formed in the respective core pieces 40a and 40b may be coupled to each other so as to face each other. Therefore, in this exemplary embodiment, the air gaps S of the side legs 42a and 42b may have a length corresponding to a length of two contact parts 43 or a length two times larger than a protrusion length of the contact part 43.

Meanwhile, a configuration of the core pieces 40a and 40b according to an exemplary embodiment of the present disclosure is not limited to the above-mentioned configuration, but may be variously applied. That is, the contact part 43 may be formed at only any one of the side legs 42a and 42b or a plurality of contact parts 43 may be formed. In addition, the contact parts 43 may be extended from inner surfaces of the side legs 42a and 42b or may be extended from several surfaces.

The core 40 may be formed of Mn—Zn based ferrite having higher permeability, lower loss, higher magnetic flux saturation density, higher stability, and a lower production cost, as compared with other materials. However, in an embodiment of the present disclosure, a material of the core 40 is not particularly limited.

In the core and the coil component including the same according to this exemplary embodiment configured as described above, when the two core pieces are coupled to each other, the ends of the side legs do not entirely contact each other, but may contact each other in a relatively small area through the contact parts protruding from the side legs.

Therefore, since the gaps are formed between the side legs by the contact parts, aside gap type core or a center-side gap type core may be easily manufactured.

In addition, since the gaps between the two core pieces are determined by the protrusion lengths of the contact parts, a side gap type core or a center-side gap type core in which widths of gaps are constant may be manufactured only by coupling the two core pieces to each other.

Therefore, since insulators or other materials do not need to be inserted into the gaps, the number of manufacturing processes may be decreased. As a result, a manufacturing cost may be decreased.

Meanwhile, in the core according to this exemplary embodiment, the side legs may partially contact each other by the contact part.

Therefore, in the case in which magnetic flux in the core is increased, magnetic flux saturation may be easily generated at the contact part. The contact part at which the magnetic flux saturation is generated may provide a state similar to air having magnetic permeability of 1.

Therefore, in this case, the contact part may function as an air gap. That is, the core according to this exemplary embodiment may be in the same state as the state in which only the air gaps are formed between the side legs in the case in which the magnetic flux is saturated in the contact part, such that it may perform an operation that is substantially the same as that of the side gap type core or the center-side gap type core.

Meanwhile, in the core, an inductance value in the case in which the magnetic flux is saturated in the contact part and an inductance value in the case in which the magnetic flux is not saturated in the contact part need to be the same as each other. Further, in the case in which the magnetic flux is saturated in the contact part, magnetic permeability may ideally be 1. However, an error may be present due to temperature characteristics and material characteristics of the core.

In this case, inductance values may be controlled to be the same as each other by a width of the air gap, that is, a protrusion length of the contact part. Therefore, the protrusion length of the contact part may be set to correspond to a required inductance value.

Meanwhile, the present disclosure is not limited to the above-mentioned exemplary embodiments, but may be variously applied.

FIGS. 4 through 13 are perspective views illustrating a core according to another exemplary embodiment of the present disclosure. In FIGS. 4 through 13, only one core piece is shown for convenience of description.

Referring to FIG. 4, in a core piece according to this exemplary embodiment, contact parts 43 may protrude in a form in which inner surfaces of side legs 42a and 42b are extended. In this case, when two core pieces are coupled to each other, air gaps S of the side legs 42a and 42b may be formed at outer sides of the contact parts 43.

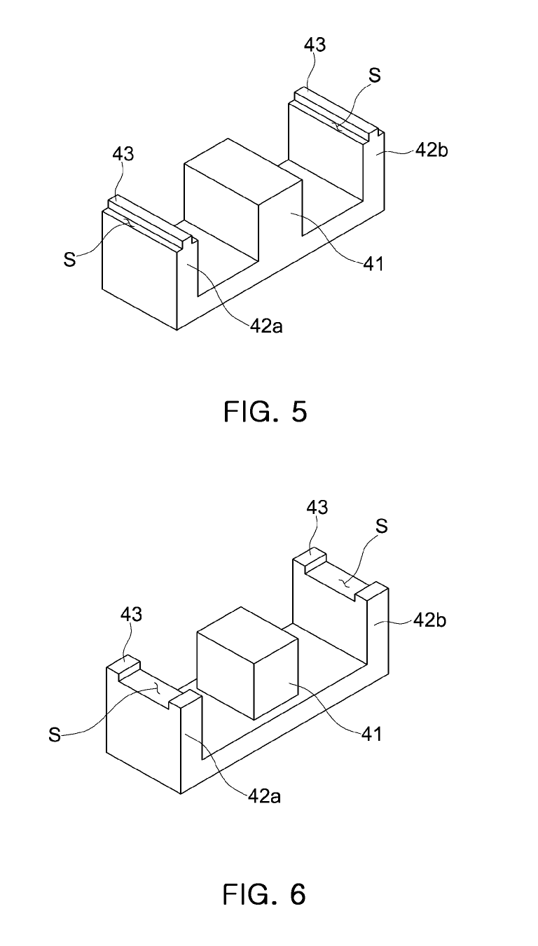

Referring to FIG. 5, in a core piece according to this exemplary embodiment, contact parts 43 may protrude along the centers of side legs 42a and 42b. In this case, when two core pieces are coupled to each other, air gaps S of the side legs 42a and 42b may be formed on both sides of the contact parts 43, respectively.

Referring to FIG. 6, in a core piece according to this exemplary embodiment, contact parts 43 may be formed in a form in which they protrude from both distal ends of the side legs 42a and 42b in a length direction, respectively. Therefore, two contact parts 43 may be formed at each of the side legs 42a and 42b. In addition, when two core pieces are coupled to each other, air gaps S of the side legs 42a and 42b may be formed at inner sides of the contact parts 43.

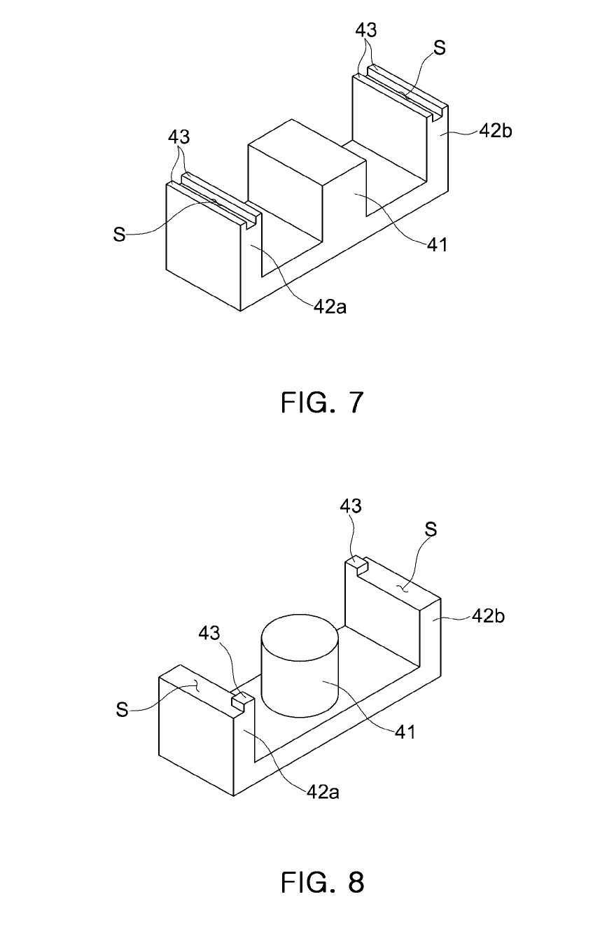

Referring to FIG. 7, in a core piece according to this exemplary embodiment, contact parts 43 may be formed in a form in which they protrude from inner and outer surfaces of the side legs 42a and 42b, respectively. Therefore, two contact parts 43 may be formed at each of the side legs 42a and 42b. In addition, when two core pieces are coupled to each other, air gaps S of the side legs 42a and 42b may be formed between the two contact parts 43.

Referring to FIG. 8, in a core piece according to this exemplary embodiment, contact parts 43 may be disposed to be diagonal with respect to the center leg 41. That is, one contact part 43 may be formed at one distal end of one side leg 42a in a length direction, and the other contact part 43 may be formed at the other distal end of the other side leg 42b in the length direction.

In this case, when two core pieces are coupled to each other, the contact parts 43 of one core piece does not contact the contact parts 43 of the other core piece, but may contact distal ends of the side legs 42a and 42b while facing the distal end of the side legs 42a and 42b. Therefore, widths of air gaps S of the side legs 42a and 42b may correspond to protrusion lengths of the contact parts 43.

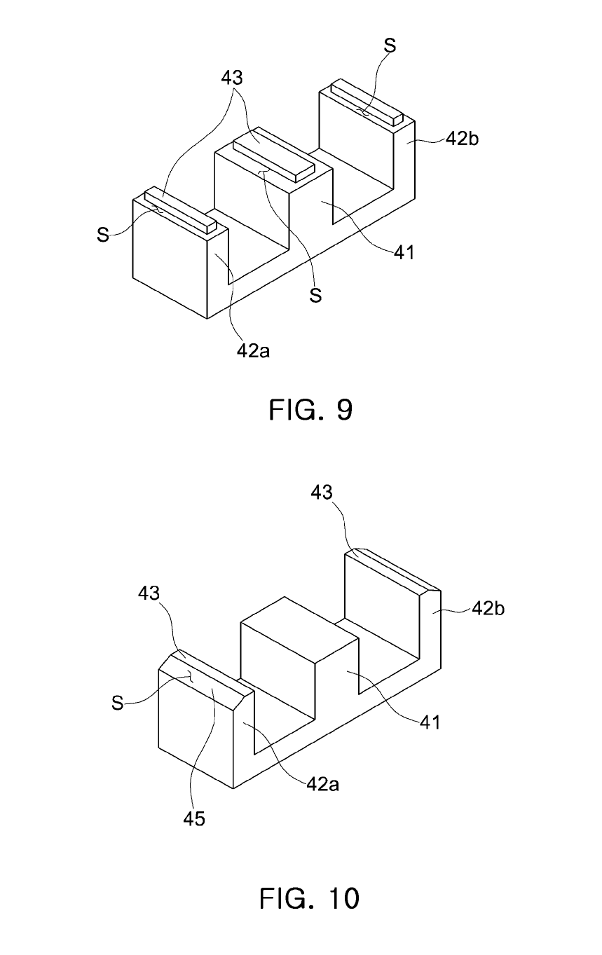

Referring to FIG. 9, in a core piece according to this exemplary embodiment, contact parts 43 may protrude from the centers of side legs 42a and 42b. In this case, when two core pieces are coupled to each other, air gaps S of the side legs 42a and 42b may be formed along vicinities of the contact parts, respectively.

Further, in the core piece according to this exemplary embodiment, a contact part 43 may also protrude from a center leg 41. As described above, the contact parts 43 according to an exemplary embodiment of the present disclosure are not limited to being formed at the side legs 42a and 42b, but may be formed in various locations such as the center leg 42, and the like, if necessary, depending on a shape of the core.

Referring to FIG. 10, in core pieces 40a and 40b according to this exemplary embodiment, contact parts 43 do not protrude in a protrusion form from distal ends of side legs 42a and 42b, but may have a form in which cross-sectional areas of the side legs 42a and 42b are decreased. Therefore, at least one of side surfaces of the contact part 43 may be formed as an inclined surface 45 connected to outer surfaces of the side legs 42a and 42b.

In this exemplary embodiment, the contact parts 43 may be formed by extending inner surfaces of the side legs 42a and 42b and the inclined surfaces 45 may be formed by connecting the outer surfaces of the side legs 42a and 42b to the contact parts 43.

In the case in which the core pieces are formed as described above, air gaps S of the side legs 42a and 42b may not have uniform widths, but have widths becoming wider as they become farther away from the contact parts 43.

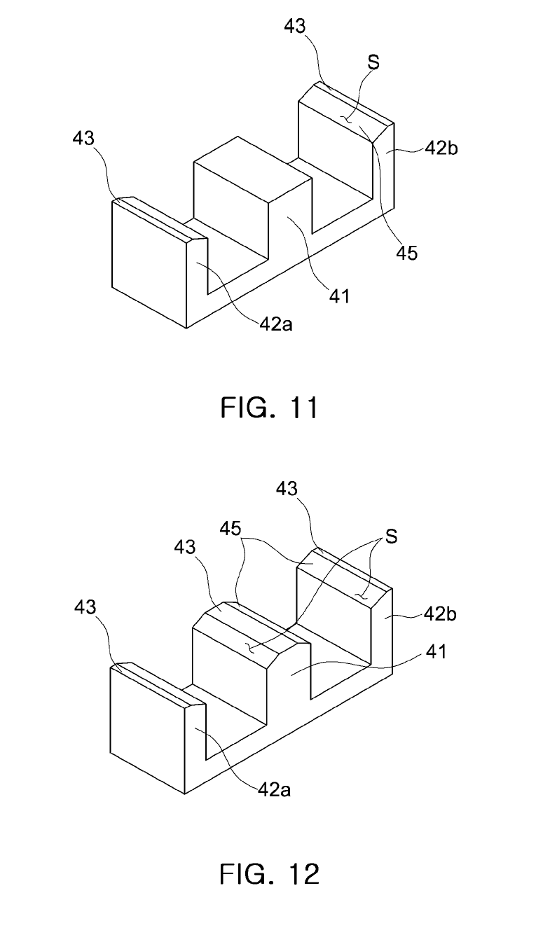

Referring to FIG. 11, a core piece according to this exemplary embodiment may include contact parts 43 having inclined surfaces 45, similar to the core piece shown in FIG. 10. Further, the case in which the contact parts 43 are formed by extending outer surfaces of side legs 42a and 42b and the inclined surfaces 45 are formed by connecting inner surfaces of the side legs 42a and 42b to the contact parts 43 is shown by way of example in FIG. 11.

Referring to FIG. 12, a core piece according to this exemplary embodiment may be formed to be similar to the core piece shown in FIG. 11. Further, the case in which a contact part is also formed at a center leg 41 and inclined surfaces 45 are formed on both sides of the contact parts 43, respectively, is shown by way of example in FIG. 12.

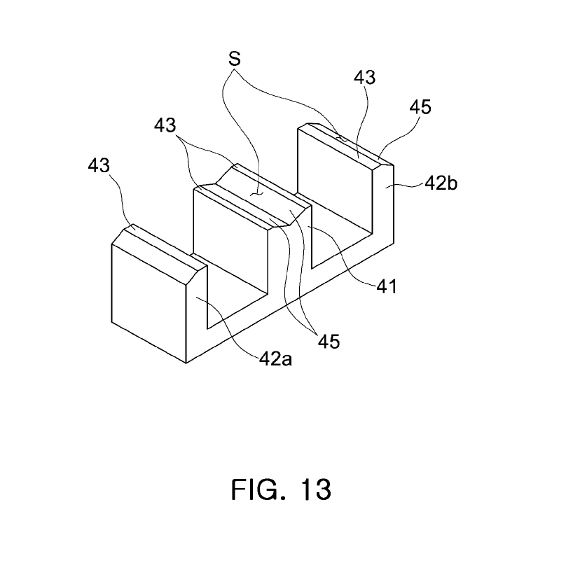

Referring to FIG. 13, a core piece according to this exemplary embodiment may be formed, similar to the core piece shown in FIG. 10. Further, the case in which contact parts 43 are formed at a center leg 41, more specifically, at both ends of the center leg 41, respectively, and inclined surfaces 45 having a V-shaped valley shape are formed between the contact parts 43 is shown by way of example in FIG. 13.

The core and the coil component including the same according to the present disclosure as described above is not limited to the above-mentioned exemplary embodiments, but may be variously applied.

For example, although the ‘EE’ core has been described by way example in the above-mentioned exemplary embodiments, the present disclosure is not limited thereto, but may be applied to various types of cores such as an ‘EI’ core, a ‘UU’ core, a ‘UI’ core, and the like.

Further, although the transformer has been described by way of example in this exemplary embodiment, the present disclosure is not limited thereto, but may be widely applied to any coil component including a coil.

As set forth above, with the core according to an exemplary embodiment of the present disclosure, when the two core pieces are coupled to each other, the ends of the side legs do not entirely contact each other, but may contact each other at a relatively small area by the contact parts protruding from the side legs.

Therefore, since the gaps are formed between the side legs by the contact parts, a side gap type core or a center-side gap type core may be easily manufactured.

In addition, since the gaps between the two core pieces are determined by the protrusion lengths of the contact parts, a side gap type core or a center-side gap type core in which widths of gaps are constant may be manufactured only by coupling the two core pieces to each other.

Therefore, since insulators or other materials do not need to be inserted into the gaps, the number of manufacturing processes may be decreased. As a result, a manufacturing cost may be decreased.

While exemplary embodiments have been shown and described above, it will be apparent to those skilled in the art that modifications and variations could be made without departing from the spirit and scope of the present disclosure as defined by the appended claims.

What is claimed is:

1. A core comprising core pieces coupled to each other, each of the core pieces including:
a plurality of legs;
a connection part connecting one ends of the legs to each other; and
at least one contact part formed at a distal end of at least one of the legs in a manner in which a cross-sectional area of the leg is decreased.

2. The core of claim 1, wherein the core pieces are coupled to each other while contacting each other through distal ends of the contact parts.

3. The core of claim 2, wherein the contact part protrudes from the distal end of the leg in a stepped manner.

4. The core of claim 2, wherein each of the core pieces further includes at least one inclined surface connecting the distal end of the contact part and the distal end of the leg.

5. The core of claim 2, wherein the core pieces are coupled to each other while the distal ends of the contact parts contact each other.

6. The core of claim 2, wherein the core pieces are coupled to each other while the distal end of the contact part formed on any one of the core pieces contacts the distal end of the leg of the other of the core pieces.

7. The core of claim 2, wherein the legs include side legs disposed at both ends of the connection part and a center leg disposed between the side legs.

8. The core of claim 7, wherein the contact parts are formed at distal ends of the side legs, respectively.

9. The core of claim 8, wherein the contact parts are formed to be diagonal with respect to the center leg.

10. The core of claim 7, wherein the contact parts have a form in which they extend outer surfaces or inner surfaces of the side legs.

11. The core of claim 2, wherein air gaps are formed in positions in which the legs face each other at outer sides of the contact parts.

12. A core comprising:
a plurality of legs; and
a connection part connecting one ends of the legs to each other,
wherein at least one of the legs includes at least one contact part having a form in which a cross-sectional area of the leg is decreased.

13. A coil component comprising:
a core formed by coupling at least two core pieces to each other; and
a bobbin having a coil wound therein and having the core coupled thereto,
wherein at least one of the core pieces includes legs, the legs including contact parts formed at distal ends thereof in a manner in which cross-sectional areas thereof are decreased and surface-contacting the other core piece.

14. The coil component of claim 13, wherein the core pieces are coupled to each other while contacting each other through distal ends of the contact parts.

15. The coil component of claim 14, wherein air gaps are formed in positions in which the legs face each other at outer sides of the contact parts.

16. The coil component of claim 15, wherein the contact part functions as an air gap in the case in which magnetic flux is increased and saturated in the core.
